(19) United States
(12) Patent Application Publication
(10) Pub. No.: US 2007/0027948 A1
(43) Pub. Date: Feb. 1, 2007

(54) Server blades connected via a wireless network

(75) Inventor: David Robert Engebretsen, Cannon Falls, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/165,384

(22) Filed: Jun. 23, 2005

(51) Int. Cl. G06F 15/16

(52) U.S. Cl. 709/203

(57) ABSTRACT

A method, apparatus, system, and signal-bearing medium that, in an embodiment, connect service processors in server blades via a wireless network. The server blades include a wireless network interface adapter, which connects the server blades to a master service processor in a blade management controller. The master service processor uses the wireless network to send commands to each server blade in response to a user interface. The commands may include such functions as controlling power to the server blades, updating firmware on the server blades, configuring partitions at the server blades, and collecting diagnostic information from the server blades. In various embodiments, the server blades may be mounted in a housing connected via a backplane or midplane, and the server blades may be in the same housing as the blade management controller or in a different housing. In an embodiment, service processors on server machines mounted in a rack may be connected via a wireless network. In this way, a higher bandwidth network may be provided for service processor functions while decreasing the need for use of the expensive real estate on a midplane or backplane.

### FIELD

An embodiment of the invention generally relates to server computer systems. In particular, an embodiment of the invention generally relates to server blades connected via a wireless network.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are much more powerful than just a few years ago.

One use of high performance computer systems is a server that provides services to entities known as clients, often connected via a network. Heretofore, a sever computer system frequently was self-contained within an appropriate chassis or housing. But, as demands on server computer systems have increased with the increasing spread of networks and the services available through networks, alternative technologies have been proposed to improve server computer system capabilities. One such proposal is a format known as a server blade.

A blade server system provides functionality that is comparable to or beyond that previously available in a free-standing or self-contained server by housing multiple server blades in a compact space and in a common chassis. Each system is configured to be present in a compact package known as a server blade, which can be inserted in the chassis along with a number of other server blades, analogous to books in a bookshelf. The server blade typically includes processors and memory on a single board and may function as an independent server, with its own storage, network controllers, operating system, and applications. The server blades may be general-purpose servers, or they may be tailored and preconfigured for specific data center needs (e.g., as security blades with a firewall, virtual private network (VPN), and intrusion detection software preinstalled). The server blades may be, but are not necessarily, connected to each other and may use common system software to form a server group or server system consisting of these blades.

At least some services for the server blades are consolidated, so that the services can be shared among the server blades housed in common. These consolidated services may include one or more of power, cooling, network access, and storage services, among others. These consolidated services, which may be shared among a collection of server blades, are often accessed through a connection plane (e.g., a backplane or midplane) of the chassis; for example, the power and bus connections may be a part of the cabinet that houses a collection of the server blades.

The server blade configuration provides a number of advantages over traditional rack-mounted servers. First, server blades are typically more easily installed and removed than rack-mounted servers. Second, with a large number of high-performance server blades in a single chassis sharing common services, blade technology may achieve high levels of density at a low cost with ease of future expansion and installation. Third, fewer components are duplicated, so that the number of cables, switches, and power distribution units may be reduced. Fewer components result in fewer items that can fail or need repair, and modular scalability helps spread capital equipment costs over time. Fourth, all critical components of a server blade can be made redundant or hot-swappable, including cooling systems, power supplies, Ethernet controllers and switches, mid- and backplanes, hard disk drives, and service processors. Thus, removing a server for maintenance just means sliding the server blade out of the chassis. Fifth, in advanced server blade systems, when a server blade is slid into a profiled bay, the system automatically loads a designated operating system and application image into the server blade, so that the server blade initializes and runs without human intervention. Hence, adding a new server may involve little more than sliding a new blade into an open bay in the chassis.

Because of the aforementioned advantages of server blades, designers of computer systems are interested in redesigning previously-existing larger rack-mounted server systems to use the server blade technology. But, redesigning a large system to fit in a smaller space has some challenges, and one of these challenges involves accommodating service processors on the server blades. A server blade typically includes a minimal service processor, which connects to a central master service processor via a low-bandwidth interface, such as an I2C (Inter-Integrated Circuit) bus. A service processor is an auxiliary processor that monitors the environment and health of one or more main processors and their associated subsystems. In the event of an actual or predicted problem with a main processor, subsystem, or the server blade environment, the service processor is capable of taking action to alert a system administrator and/or to correct the problem on its own.

In contrast to server blades, many of today's larger rack-mounted server systems use a more elaborate service processor, which includes a high-bandwidth interface such as Ethernet. The service processor uses this high-bandwidth interface to manage the system, load large firmware images, control firmware configurations such as logical partitioning characteristics, and connect to a terminal that provides overall management function interfaces. Designers of computer systems would like to redesign the elaborate rack-mounted systems to fit into the more dense form factor of a server blade, in order to enjoy the aforementioned advantages of the server blade technology. Unfortunately, the low-bandwidth interface of, e.g., I2C, while sufficient for the minimal service processors of typical blade technology, is not sufficient for the needs of the more elaborate server processors used in rack-mounted systems. In addition, the server blade chassis typically has insufficient backplane real estate available to provide one or more hard wired Ethernet connections for a service processor network, which typically has a very low average utilization. Adding additional space on the backplane or midplane to accommodate a wired Ethernet connection for the service processors in the server blades would be prohibitively expensive, and a better use for any additional space on the backplane would be a network with a high average utilization.

Thus, without a better way to connect service processors in server blades, designers of computer systems will continue to struggle with redesigning large rack-mounted server systems to use server blade technology.

### SUMMARY

A method, apparatus, and system are provided that, in an embodiment, connect service processors in server blades via a wireless network. The server blades include a wireless network interface adapter, which connects the server blades to a master service processor in a blade management controller. The master service processor uses the wireless network to send commands to each server blade in response to a user interface. The commands may include such functions as controlling power to the server blades, updating firmware on the server blades, configuring partitions at the server blades, and collecting diagnostic information from the server blades. In various embodiments, the server blades may be mounted in a housing connected via a backplane or midplane, and the server blades may be in the same housing as the blade management controller or in a different housing. In an embodiment, service processors on server machines mounted in a rack may be connected via a wireless network. In this way, a higher bandwidth network may be provided for service processor functions while decreasing the need for use of the expensive real estate on a midplane or backplane.

### BRIEF DESCRIPTION OF THE DRAWINGS

Various embodiments of the present invention are hereinafter described in conjunction with the appended drawings:

FIG. 1 depicts a perspective view of an example server system of server blades and a chassis connected via a wireless network, according to an embodiment of the invention.

FIG. 2 depicts a perspective view of an example server system of server machines housed in a rack and connected via a wireless network, according to an embodiment of the invention.

FIG. 3 depicts a perspective view of an example server system with server blades and multiple chassis connected via a wireless network between the chassis, according to an embodiment of the invention.

FIG. 4 depicts a block diagram of an example server system of server blades and a blade management controller connected via a wireless network, according to an embodiment of the invention.

FIG. 5 depicts a block diagram of an example server system of server blades and a blade management controller, wherein some of the components are connected via a wireless network, according to an embodiment of the invention.

FIG. 6 depicts a block diagram of an example server system of server blades and a blade management controller, wherein some of the components are connected via a wireless network and wherein a terminal performs some of the functions of a master service processor, according to an embodiment of the invention.

FIG. 7 depicts a block diagram of an example server system of server machines and a server machine management controller connected via a wireless network, according to an embodiment of the invention.

FIG. 8 depicts a flowchart of processing for the example server blades and blade management controller, according to an embodiment of the invention.

FIG. 9 depicts a flowchart of processing for the example server machines and server machine controller, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

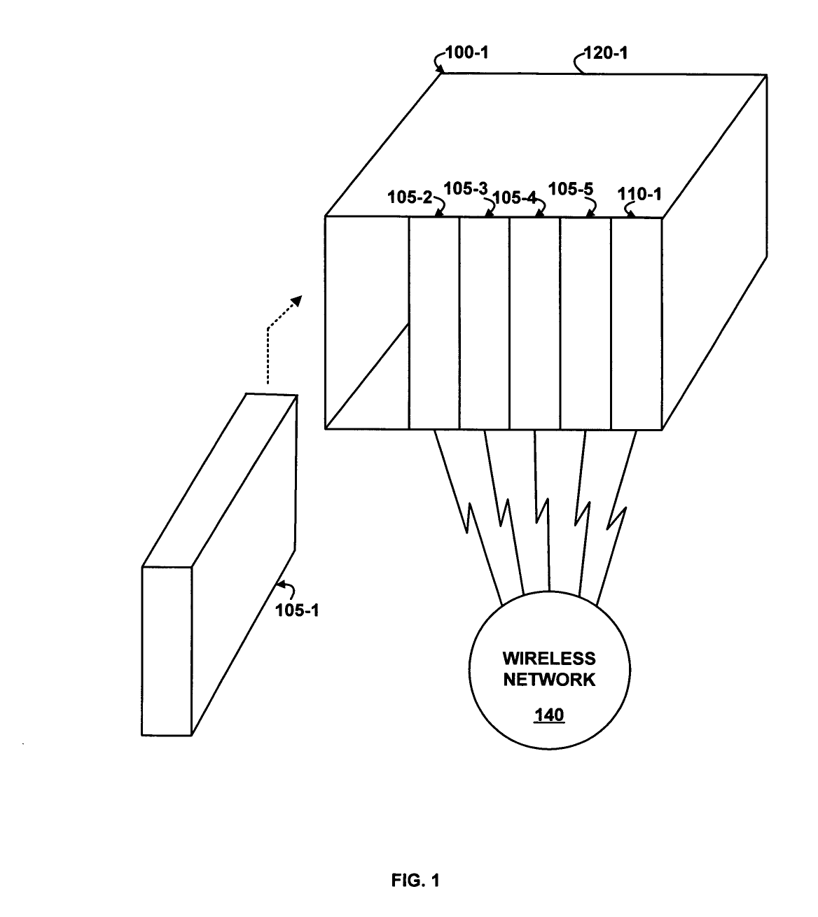

Referring to the Drawings, wherein like numbers denote like parts throughout the several views, FIG. 1 depicts a perspective view of an example server system apparatus connected via a wireless network. While the view is simplified and certain elements to be here described are not visible, the apparatus is shown to have a chassis 100-1 in which may be housed a plurality of server blades 105-1, 105-2, 105-3, 105-4, 105-5, generically referred to herein as the server blades 105. One server blade 105-1 is shown as withdrawn from the chassis 100-1, with an indication that the server blade 105-1 may be inserted into the chassis 100-1, but all of the server blades 105 may be similarly inserted to and withdrawn from the chassis 100-1.

The chassis 100-1 also houses a blade management controller 110-1, which is generically referred to herein as a blade management controller 110. Although the blade management controller 110-1 is shown inserted into the chassis 100-1 in a similar fashion as the server blades 105-2, 105-3, 105-4, and 105-5, the blade management controller 110-1 may also be withdrawn from the chassis 100-1 in a similar fashion as the server blade 105-1. In use, the server blades 105 and the blade management controller 110-1 are mounted within the common housing of the chassis 100-1 and are interconnected there within by a backplane 120-1. In various embodiments, the backplane 120-1 may implement an Ethernet network (the Ethernet IEEE (Institute of Electrical and Electronics Engineers) 802.3x specification), Infiniband, PCI express, or Fibre Channel (FC), but in other embodiments any appropriate protocol, network, or combination of networks may be used. The backplane 120-1 typically includes wire traces, and the network typically connects to a switch that may connect to another network.

In the embodiment illustrated in FIG. 1, all of the server blades 105 are disposed within the same housing, which is the chassis 100-1, but in other embodiments, some or all of the server blades 105 and the blade management controller 110 may be disposed in different housings.

The backplane 120-1 is generically referred to herein as a wired connector 120. In an embodiment, the backplane 120-1 is a circuit board at the rear of the chassis 100-1 that includes sockets into which the server blades 105 and the blade management controller 1101 may be plugged. In another embodiment, a midplane may be used in lieu of a backplane. A midplane performs the same functions as a backplane, but is disposed in the middle of the chassis 100-1 and has sockets on both sides, so that the server blades 105 may be inserted from both the front and the rear of the chassis 100-1. The backplane 120-1 provides a common bus and connects each of the server blades 105 to each other and to the blade management controller 110-1 without the need for cables. In another embodiment, the backplane 120-1 connects the server blades 105 to the blade management controller 110-1, but not to each other. The backplane 120-1 may further provide one or more common services to the server blades 105 and the blade management controller 110-1, such as power, cooling, network access, and storage services. Although the blade management controller 110-1 is illustrated as being inserted in the same chassis 100-1 as the server blades 105, and interconnected via the same backplane 120-1, in another embodiment, the blade management controller 110-1 may be inserted into an different chassis and connected to a different backplane from the server blades 105.

The server blades 105 and the blade management controller 110-1 are also connected via a wireless network 140. The wireless network 140 may be any suitable wireless network or combination of wireless networks and may support any appropriate protocol suitable for communication of data between the server blades 105 and the blade management controller 110-1 and/or between the server blades 105. In another embodiment, the wireless network 140 may support the Ethernet IEEE (Institute of Electrical and Electronics Engineers) 802.3x specification. In another embodiment, the wireless network 140 may be a wireless Internet network and may support IP (Internet Protocol). In another embodiment, the wireless network 140 may be a local area network (LAN) or a wide area network (WAN). In another embodiment, the wireless network 140 may be a hotspot service provider network. In another embodiment, the wireless network 140 may be an intranet. In another embodiment, the wireless network 140 may be a GPRS (General Packet Radio Service) network. In another embodiment, the wireless network 140 may be a FRS (Family Radio Service) network. In another embodiment, the wireless network 140 may be any appropriate cellular data network or cell-based radio network technology. In another embodiment, the wireless network 140 may be an IEEE 802.11B wireless network. In another embodiment, the wireless network 140 may be Bluetooth. In still another embodiment, the wireless network 140 may be any suitable network or combination of networks. Although one wireless network 140 is shown, in other embodiments any number of wireless networks (of the same or different types) may be present.

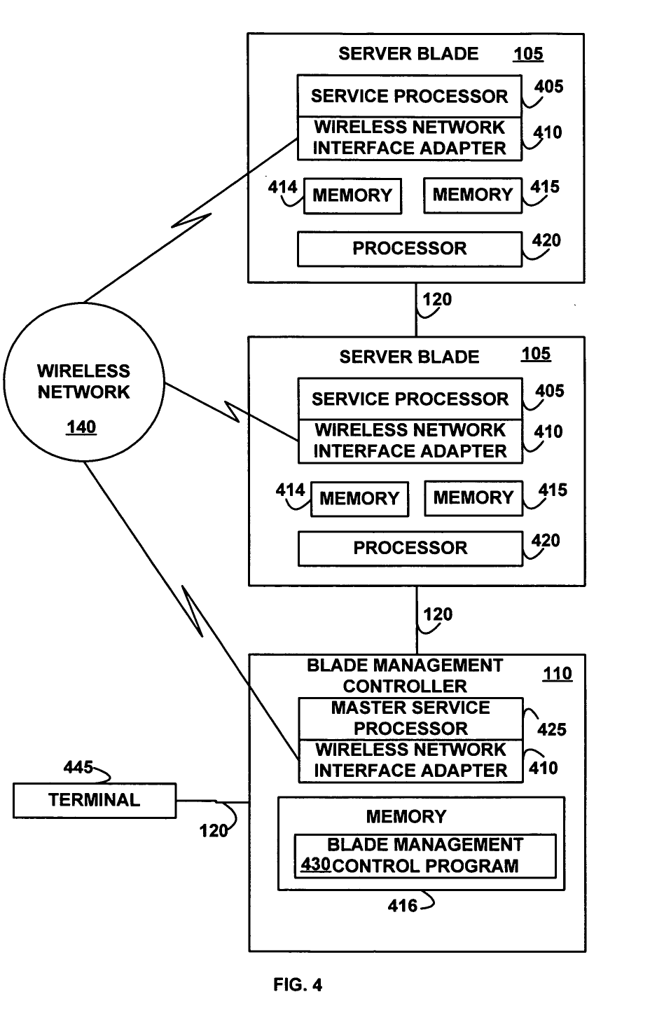

While this organization of the server system has novelty apart from the embodiment of the invention here described in FIG. 1, and is described more fully elsewhere, it is to be understood as providing the context in which an embodiment of the present invention is implemented. This general organization may be varied, as by providing the blade management controller 110-1 as one of the server blades 105 and using a midplane as distinguished from the backplane, all while adopting an embodiment of the invention here disclosed. Further, any organization and number of the server blades 105 and the blade management controller 110-1 may be present. The server blades 105 and the blade management controller 110-1 are further described below with reference to FIGS. 4, 5, 6, and 8.

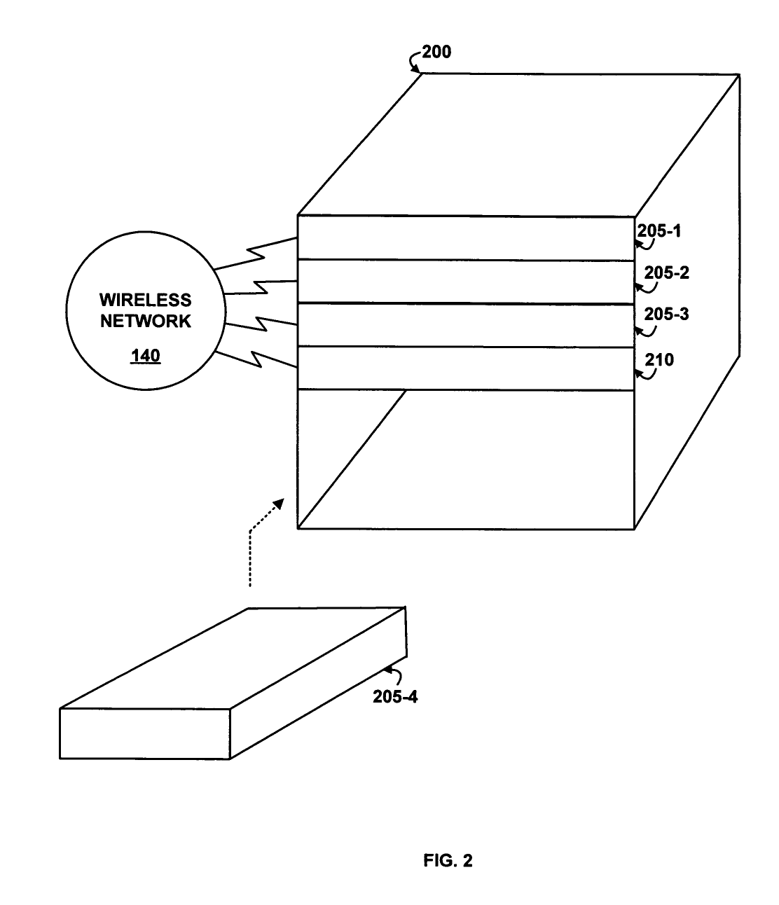

FIG. 2 depicts a perspective view of an example server system of server machines capable of being mounted in a rack 200 and connected via a wireless network 140, according to an embodiment of the invention. The rack 200 may house a plurality of server machines 205-1, 205-2, 205-3, 205-4, which are generically referred to herein as the server machines 205. In various embodiments, some or all of the server machines 205 may be implemented as a single circuit board or multiple circuit boards. One server machine 205-4 is shown as withdrawn from the rack 200, with an indication that the server machine 205-4 may be inserted into the rack 200, but all of the server machines 205 may be similarly inserted to and withdrawn from the rack 200.

The rack 200 also houses a server machine management controller 210. Although the server machine management controller 210 is shown inserted into the rack 200 in a similar fashion as the server machines 205-1, 205-2, and 205-3, the server machine management controller 210 may also be withdrawn from the rack 200 in a similar fashion as the server machine 205-4. In use, the server machines 205-1, 205-2, 205-3, and 205-4 and the server machine management controller 210 are mounted within the common housing of the rack 200. The rack-mounted server system of FIG. 2 differs from FIG. 1 in that the rack 200 does not have a backplane with common servers, so the server machines 205 and the server machine management controller 210 are in communication only via the wireless network 140. In the embodiment illustrated in FIG. 2, all of the server machines 205 and the server machine management controller 210 are disposed within the same housing, which is the rack 200, but in other embodiments, some or all of the server machines 205 and the server machine management controller 210 may be disposed within different housings.

In an embodiment, the server machines 205-1, 205-2, 205-3, and 205-4 and the server machine management controller 210 are implemented as 1 U devices, but in other embodiments any appropriate device technology may be used. “U” is the industry standard unit of measure for designating the vertical usable space, or height of racks (metal frame designed to hold hardware devices) and cabinets (enclosures with one or more doors), but in other embodiments any appropriate units of measure may be used. This unit of measurement refers to the space between shelves on a rack. 1 U is equal to 1.75 inches. For example, a rack designated as 20 U, has 20 rack spaces for equipment and has 35 (20×1.75.) inches of vertical usable space, but any appropriate number of rack spaces and dimensions may be used. In an embodiment, rack and cabinet spaces and the equipment which fit into them are all measured in units of U.

While this organization of the server system apparatus has novelty apart from the embodiment of the invention here described in FIG. 2, and is described more fully elsewhere, it is to be understood as providing the context in which an embodiment of the present invention is implemented. This general organization may be varied, as by providing the server machine management controller 210 as one of the server machines 205, all while adopting an embodiment of the invention here disclosed.

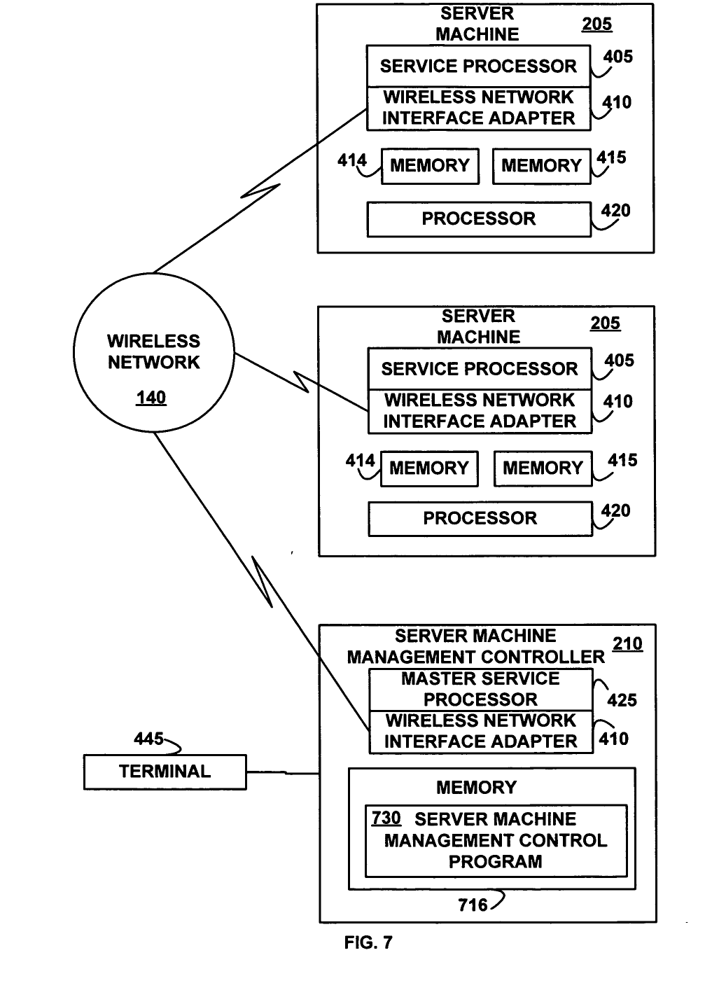

Further, any appropriate organization and number of the server machines 205 and the server machine management controller 210 may be present. The server machines 205 and the server machine management controller 210 are further described below with reference to FIG. 7.

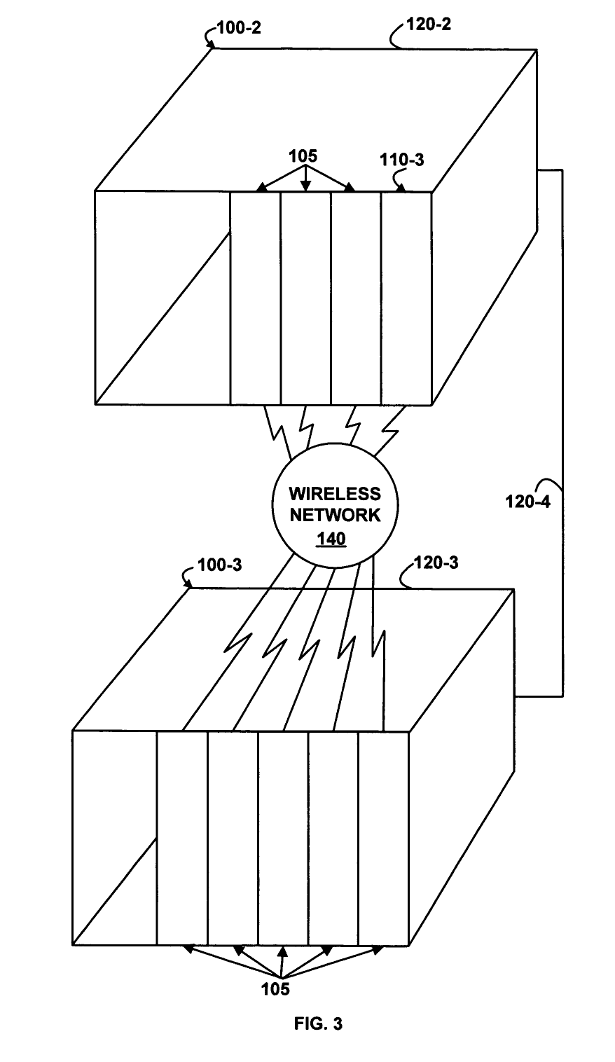

FIG. 3 depicts a perspective view of an example server system with a blade management controller 110-3 and server blades 105 connected via the wireless network 140 between the chassis 100-2 and 100-3, according to an embodiment of the invention. The server blades 105 and the blade management controller 110-3 in the chassis 100-2 are further connected via a backplane 120-2, as previously described above with reference to FIG. 1. The server blades 105 in the chassis 100-3 are further connected via a backplane 120-3, as previously described above with reference to FIG. 1 The blade management controller 110-3 is generically referred to herein as the blade management controller 110. The chassis 100-2 and 100-3 (and thus the server blades 105 and the blade management controller 110-3) are also connected via a wired connector 120-4, which in an embodiment is a cable, but in other embodiments any be any appropriate type of wired network. In the embodiment illustrated in FIG. 3, some of the server blades 105 are disposed within different housings (the chassis 100-2 and 100-3), but in other embodiments, some or all of the server blades 105 and the blade management controller 110 may be disposed in the same housing.

While this organization of the server system apparatus has novelty apart from the embodiment of the invention here described in FIG. 3, and is described more fully elsewhere, it is to be understood as providing the context in which an embodiment of the present invention is implemented. This general organization may be varied, as by providing the blade management controller 110-3 as one of the server blades 105, all while adopting an embodiment of the invention here disclosed. Further, any appropriate organization and number of the server blades 105 and the blade management controller 110-3 may be present. The server blades 105 and the blade management controller 110-3 are further described below with reference to FIGS. 4, 5, and 6.

FIG. 4 depicts a block diagram of an example server system of server blades 105 and a blade management controller 110 connected via a wireless network 140, according to an embodiment of the invention. The server blades 105 and the blade management controller 110 are further connected via the connectors 120, which generically refer to any or all of the backplane 120-1 (FIG. 1), the backplanes 120-2 and 120-3 (FIG. 3), and the cable 120-3 (FIG. 3). Each server blade 105 includes a combined service processor 405 and wireless network interface adapter 410, a main processor 420, a memory 414 used the server processor 405, and a memory 415 used by the main processor 420.

The service processor 405 is a lower function processor (than the main processor 420) employed for monitoring and signaling purposes as described hereinafter. In another embodiment, the service processor 405 has the same or higher function as the main processor 420. The concept of a service processor is well know in the field of data processing systems and particularly server class systems. Service processors are provided to manage certain aspects of a server and can be defined as an auxiliary processor that monitors the environment and health of one or more main processors (e.g., the main processor 420) and their associated subsystems. In the event of an actual or predicted problem with a main processor, subsystem, or the environment, the service processor is capable of taking action to alert a system administrator and/or to correct the problem on its own. In an embodiment, each of the service processors 405 has a unique network identifier on the wireless network 140. Although the service processor 405 is illustrated as being combined with the wireless network interface adapter 410, in another embodiment they may be packaged separately.

Each server blade 105 is provisioned with program instructions stored in the memory 414 which, when executed on the service processors 405, may perform a power on self test (POST), may perform diagnostics to determine the operating state of the server blade 105, and may load a basic input output system (BIOS) before loading an operating system (OS). The provision of POST, diagnostics, and BIOS is well known to persons of skill in the design and use of information handling systems of the general types here described. That is, POST, diagnostic, and BIOS programs have been provided in server systems of the earlier, free standing, types and such technology is employed in the server blades 105 herein described.

The wireless network interface adapter 410 connects to the wireless network 140 and, in various embodiments, may be a modem, network interface card (NIC), network adapter, I/O (Input/Output) processor, or any other appropriate type of interface capable of connecting the service processor 405 to the wireless network 140.

The memory 414 and 415 may be any appropriate memory and/or storage device or combination of devices for storing data and/or programs. The memory 414 and 415 are conceptually single monolithic entities, but in other embodiments the memory 414 and 415 are more complex arrangements, such as a hierarchy of caches and other memory devices. For example, memory may exist in multiple levels of caches, and these caches may be further divided by function, so that one cache holds instructions while another holds non-instruction data, which is used by the processor or processors. The memory 414 and 415 may include a variety of types, such as ROM (Read Only Memory), EPROM (Erasable Programmable Read Only Memory), RAM (Random Access Memory), NVRAM (Nonvolatile Random Access Memory), flash memory, a memory stick, a disk drive, or any other appropriate type of memory or storage devices. The memory 414 and 415 may further be distributed and associated with different CPUs or sets of CPUs, as is known in any of various so-called non-uniform memory access (NUMA) computer architectures.

Each of the main processors 420 represents one or more general-purpose programmable central processing units (CPUs) e.g., such as an Intel X86 based processor or a PowerPC processor, but in other embodiments any appropriate processor or combination of processors may be used. In an embodiment, the main processor 420 includes multiple CPUs typical of a relatively large system; however, in another embodiment the main processor 420 may alternatively include a single CPU. Each main processor 420 executes instructions stored in the memory 415 and may include one or more levels of on-board cache. In an embodiment, the main processors 420 in the server blades 105 send and receive data and/or commands between each other via the wired connector 120.

The blade management controller 110 includes a combined master service processor 425 and wireless network interface adapter 410 and a memory 416. The master service processor 425 in the blade management controller 110 communicates with the server blades 105 via the wireless network interface adapter 410 and the wireless network 140.

In various embodiments, the master service processor 425 may be a lower-function processor analogous to the service processors 405 or may be a higher-function processor analogous to the main processors 420. The master service processor 425 has a unique network identifier on the wireless network 140.

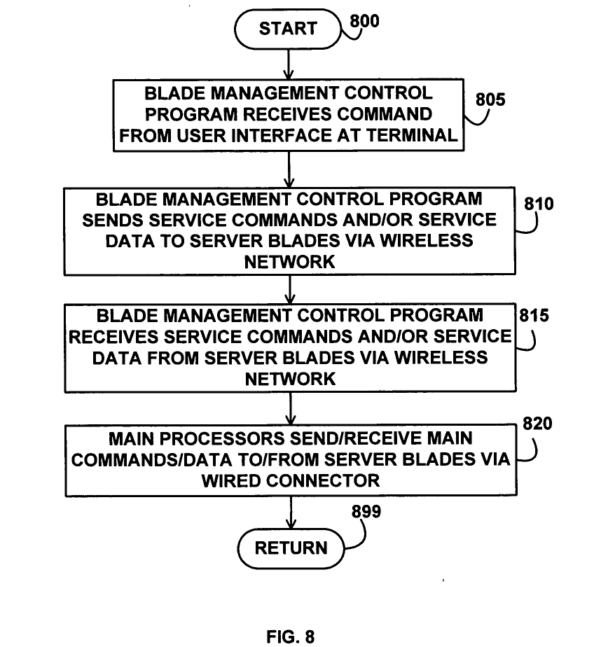

The blade management controller 110 connects to a terminal 445 via the connector 120. In various embodiments, the terminal 445 may include one or more of a video display device, projector, keyboard, speaker, mouse or other pointing device (e.g., a graphic tablet, joystick, track ball, or track pad, touchpad, or pointing stick), microphone, camera, printer, or any other appropriate device capable of presenting output to a user and/or receiving input from a user. The blade management controller 110 may use the terminal 445 to present a user interface, as further described below with reference to FIG. 8.

The memory 416 is analogous to the memory 414, as previously described above. The memory 416 includes a blade management control program 430. In an embodiment, the blade management control program 430 includes instructions capable of executing on the master service processor 425 or statements capable of being interpreted by instructions executing on the master service processor 425 to perform the functions as further described below with reference to FIG. 8. In another embodiment, the blade management control program 430 may be implemented in microcode or firmware. In another embodiment, the blade management control program 430 may be implemented in hardware via logic gates and/or other appropriate hardware techniques. Although the blade management control program 430 is illustrated as being part of the memory 416, in another embodiment the blade management control program 430 may be separate from the memory 416.

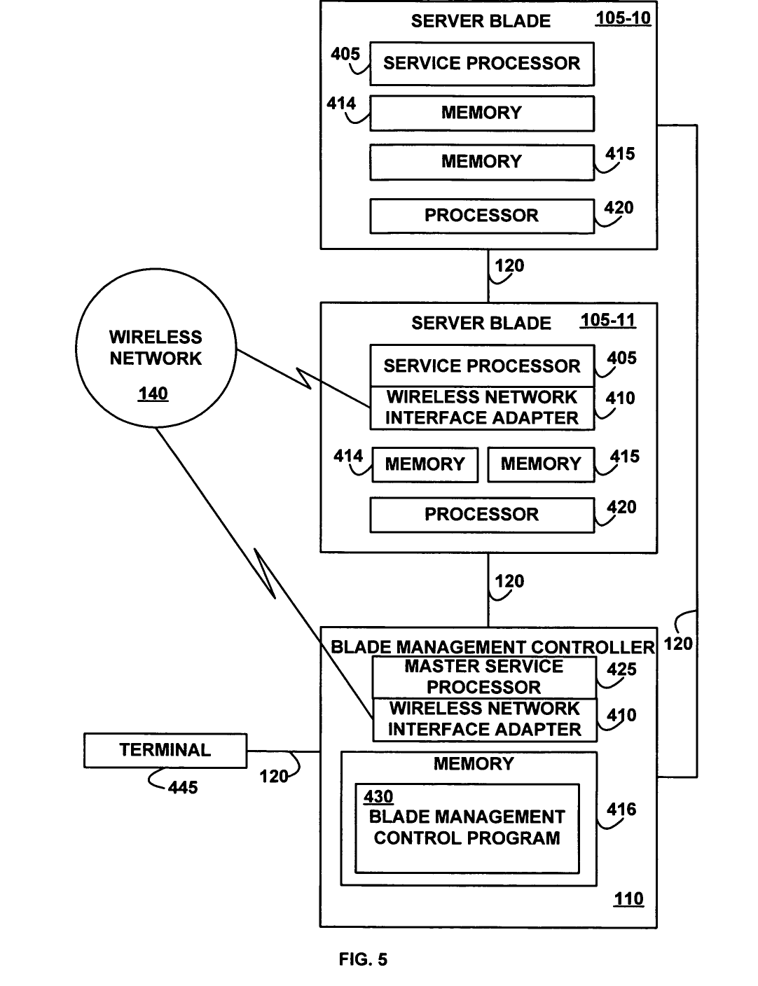

FIG. 5 depicts a block diagram of an example server system of server blades 105-10 and 105-11 and a blade management controller 110, wherein some of the components are connected via a wireless network 140 and some of the components are connected via the hardwired connector 120, according to an embodiment of the invention. The connector 120 generically refers to any or all of the backplane 120-1 (FIG. 1), the backplanes 120-2 and 120-3 (FIG. 3), or the cable 120-4 (FIG. 3). The server blades 105-10 and 105-11 are generically referred to herein as the server blades 105.

Each of the server blades 105-10 and 105-11 includes the service processor 405, the memory 414 and 415, and the main processor 420. In the server blade 105-11, the service processor 405 is combined with a wireless network interface adapter 410, so that the service processor 405 in the server blade 105-11 is connected to the blade management controller 110 through the wireless network 140 via the wireless network interface adapter 410. In contrast, in the server blade 105-10, a wireless network interface is not present, but in another embodiment may be present but not used. Instead, the service processor 405 in the server blade 105-10 is connected to the blade management controller 110 via the connector 120.

The blade management controller 110 includes a combined master service processor 425 and wireless network interface adapter 410 and a memory 416. The master service processor 425 in the blade management controller 110 communicates with the service processor 405 in the server blade 105-11 via the wireless network interface adapter 410 and the wireless network 140. The master service processor 425 in the blade management controller 110 communicates with the service processor 405 in the server blade 105-10 via the wired connector 120. In an embodiment, the main processors 420 in the server blades 105 send and receive data and/or commands between each other via the wired connector 120.

The blade management controller 110 connects to the terminal 445 via the connector 120. The blade management controller 110 may use the terminal 445 to present a user interface, as further described below with reference to FIG. 8.

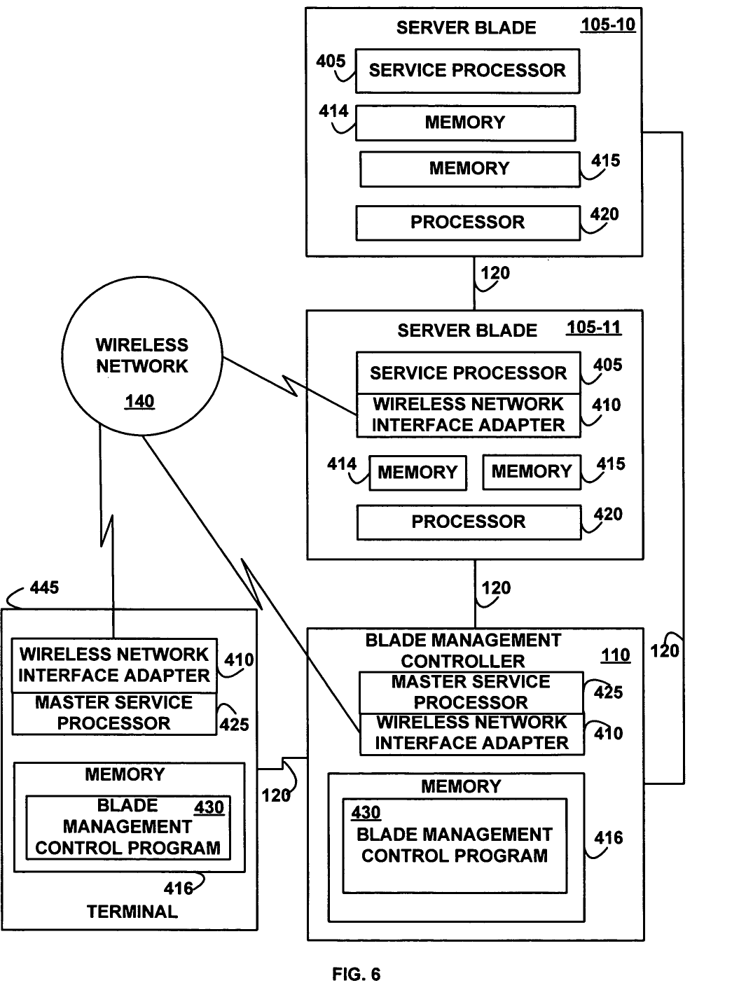

FIG. 6 depicts a block diagram of an example system of server blades 105-10, 105-11 and a blade management controller 110, wherein some of the components are connected via a wireless network 140 and some of the components are connected via the hardwired connector 120, and wherein the terminal 445 performs some of the functions of the master service processor 425, according to an embodiment of the invention. The server blades 105-10 and 105-11 are referred to generically herein as the server blades 105.

Each of the server blades 105-10 and 105-11 includes the service processor 405, the memory 414 and 415, and the main processor 420. In the server blade 105-11, the service processor 405 is combined with a wireless network interface adapter 410, so that the service processor 405 in the server blade 105-11 is connected to the blade management controller 110 through the wireless network 140 via the wireless network interface adapter 410. In contrast, in the server blade 105-10, a wireless network interface is not present, but in another embodiment may be present but not used. Instead, the service processor 405 in the server blade 105-10 is connected to the blade management controller 110 via the connector 120.

The blade management controller 110 includes a combined master service processor 425 and wireless network interface adapter 410 and memory 416. The master service processor 425 in the blade management controller 110 communicates with the service processor 405 in the server blade 105-11 via the wireless network interface adapter 410 and the wireless network 140. The master service processor 425 in the blade management controller 110 communicates with the service processor 405 in the server blade 105-10 via the wired connector 120. In an embodiment, the main processors 420 in the server blades 105 send and receive data and/or commands between each other via the wired connector 120.

The blade management controller 110 connects to the terminal 445 via the connector 120. The blade management controller 110 may use the terminal 445 to present a user interface, as further described below with reference to FIG. 8. The terminal 445 includes a combined master service processor 425 and wireless network interface adapter 410 and memory 416. The master service processor 425 in the terminal 445 may perform some or all of the functions of the master service processor 425 in the blade management controller 110, including communicating with the service processor 405 in the server blade 105-11 via the wireless network interface adapter 410 and the wireless network 140. In an embodiment, the master service processor 425 and the wireless network interface adapter 410 in the blade management controller 110 are optional, not used, or only partially used.

FIG. 7 depicts a block diagram of an example server system of server machines 205 and a server machine management controller 210 connected via a wireless network 140, according to an embodiment of the invention. Each server machine 205 includes a combined service processor 405 and wireless network interface adapter 410, a main processor 420, a memory 414 used the server processor 405, and a memory 415 used by the main processor 420.

The service processor 405 is a lower function processor (than the main processor 420) employed for monitoring and signaling purposes as described hereinafter. In other embodiments, the service processor 405 may be the same or higher function as the main processor 420. In an embodiment, each of the service processors 405 has a unique network identifier on the wireless network 140. Although the service processor 405 is illustrated as being combined with the wireless network interface adapter 410, in another embodiment they may be packaged separately.

Each server machine 205 is provisioned with program instructions stored in the memory 414 which, when executed on the service processors 405, may perform a power on self test (POST), may perform diagnostics to determine the operating state of the server machine 205, and may load a basic input output system (BIOS) before loading an operating system (OS). The provision of POST, diagnostics, and BIOS is well known to persons of skill in the design and use of information handling systems of the general types here described. That is, POST, diagnostic, and BIOS programs have been provided in server systems of the earlier, free standing, types and such technology is employed in the server machines 205 herein described.

The wireless network interface adapter 410 connects to the wireless network 140 and, in various embodiments, may be a modem, network interface card (NIC), network adapter, I/O (Input/Output) processor, or any other appropriate type of interface capable of connecting the service processor 405 to the wireless network 140.

The server machine management controller 210 includes a combined master service processor 425 and wireless network interface adapter 410 and a memory 716. The master service processor 425 in the server machine management controller 210 communicates with the server machines 205 via the wireless network interface adapter 410 and the wireless network 140. In an embodiment, the main processors 420 in the server machines 205 send and receive data and/or commands between each other via the wireless network 140.

In various embodiments, the master service processor 425 may be a lower-function processor analogous to the service processors 405 or may be a higher-function processor analogous to the main processors 420. The master service processor 425 has a unique network identifier on the wireless network 140.

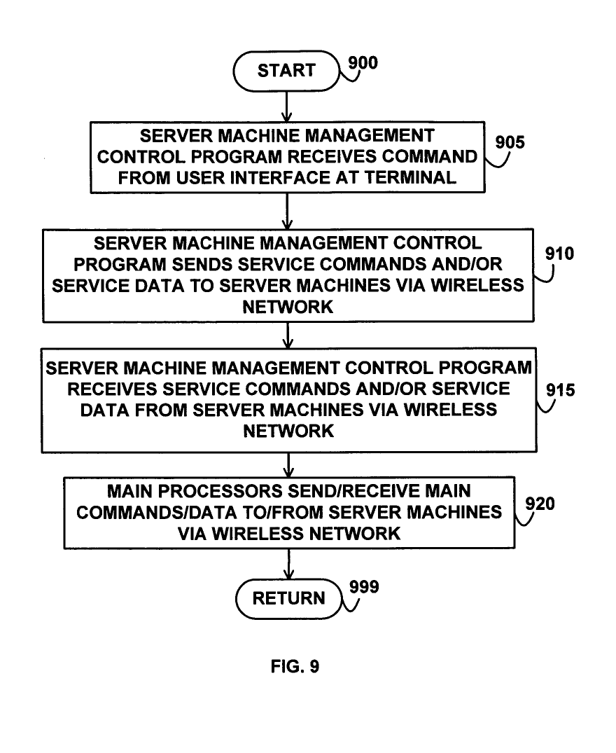

The server machine management controller 210 connects to a terminal 445. The server machine management controller 210 may use the terminal 445 to present a user interface, as further described below with reference to FIG. 9.

The memory 716 is analogous to the memory 414, as previously described above. The memory 716 includes a server machine management control program 730. In an embodiment, the server machine management control program 730 includes instructions capable of executing on the master service processor 425 or statements capable of being interpreted by instructions executing on the master service processor 425 to perform the functions as further described below with reference to FIG. 9. In another embodiment, the server machine management control program 730 may be implemented in microcode or firmware. In another embodiment, the server machine management control program 730 may be implemented in hardware via logic gates and/or other appropriate hardware techniques. Although the server machine management control program 730 is illustrated as being part of the memory 716, in another embodiment the server machine management control program 730 may be separate from the memory 716.

It should be understood that FIGS. 1, 2, 3, 4, 5, 6, and 7 are intended to depict the representative major components of the server blades 105, the blade management controller 110, the wireless network 140, the server machines 205, the server machine management controller 210, and the terminal 445 at a high level, that individual components may have greater complexity than represented in FIGS. 1, 2, 3, 4, 5, 6, and 7, that components other than or in addition to those shown in FIGS. 1, 2, 3, 4, 5, 6, and 7 may be present, and that the number, type, and configuration of such components may vary. Several particular examples of such additional complexity or additional variations are disclosed herein; it being understood that these are by way of example only and are not necessarily the only such variations.

The various software components illustrated in FIGS. 4, 5, 6, and 7 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the server blades 105, the blade management controller 110, the server machines 205, and the server machine management controller 210 and that, when read and executed by one or more processors 405, 420, and/or 425, cause the server blades 105, the blade management controller 110, the server machines 205, and/or the server machine management controller 210 to perform the steps necessary to execute steps or elements comprising the various aspects of an embodiment of the invention.

Moreover, while embodiments of the invention have and hereinafter will be described in the context of fully functioning computer systems, the various embodiments of the invention are capable of being distributed as a program product in a variety of forms, and an embodiment of the invention applies equally regardless of the particular type of signal-bearing medium used to actually carry out the distribution. The programs defining the functions of this embodiment may be delivered to the server blades 105, the blade management controller 110, the server machines 205, and/or the server machine management controller 210 via a variety of tangible signal-bearing media, which include, but are not limited to:

(1) information permanently stored on a non-rewriteable storage medium, e.g., a read-only memory device attached to or within a computer system, such as a CD-ROM, DVD-R, or DVD+R;

(2) alterable information stored on a rewriteable storage medium, e.g., a hard disk drive, CD-RW, DVD-RW, DVD+RW, DVD-RAM, or diskette; or

(3) information conveyed by a communications medium, such as through a computer or a telephone network, e.g., the wireless network 140 and/or the connector 120.

Such tangible signal-bearing media, when carrying computer-readable, processor-readable, or machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIGS. 1, 2, 3, 4, 5, 6, and 7 are not intended to limit the present invention. Indeed, other alternative hardware and/or software environments may be used without departing from the scope of the invention.

FIG. 8 depicts a flowchart of processing for the example server systems, according to an embodiment of the invention. Control begins at block 800. Control then continues to block 805 where the blade management control program 430 receives a command from the user interface at the terminal 445. In various embodiments, commands may include, for example, options to control power to individual server blades 105, update firmware, e.g., an operating system or other program in memory, on each of the server blades 105, configure logical partitions on the server blades 105, or collect diagnostic information from the server blades 105.

Control then continues to block 810 where the blade management control program 430 sends a service command and/or service data to the server blades 105 via the wireless network 140 and the wireless network interface adapter 410. The service commands and data may include controlling power to the individual server blades 105, updating firmware on the server blades 105, configuring logical partitions on the server blades 105, collecting diagnostic information from the server blades 105, or any other appropriate service functions. Control then continues to block 815 where the blade management control program 430 receives service commands and/or service data from the server blades 105 via the wireless network 140 and the wireless network interface adapter 410. In another embodiment, the blade management control program 430 communicates with some of the server blades 105 via the wireless network 140 and with some of the server blades 105 via the wired connector 120.

Control then continues to block 820 where the main processors 420 send/receive main commands/data to/from the server blades 105 and the blade management controller 110 via the wired connector 120. For example, the main commands/data sent between the server blades 105 via the wired connector 120 may send work between the server blades 105, in order to perform load balancing functions. In other embodiments, the server blades 105 may send persistent disk data (e.g., over a Fibre Channel network), messages (e.g., over an Infiniband network), or any other appropriate data. Control then continues to block 899 where the logic of FIG. 8 returns. Although the logic of FIG. 8 is illustrated as if the execution of the logic in the blocks occurs sequentially in order, in another embodiment, the logic illustrated in the blocks of FIG. 8 may occur in any order.

FIG. 9 depicts a flowchart of processing for the example server systems, according to an embodiment of the invention. Control begins at block 900. Control then continues to block 905 where the server machine management control program 730 receives a command from the user interface at the terminal 445. In various embodiments, commands may include, for example, options to control power to individual server machines 205, update firmware on each of the server machines 205, configure logical partitions on the server machines 205, or collect diagnostic information from the server machines 205.

Control then continues to block 910 where the server machine management control program 730 sends a service command and/or service data to the server machines 205 via the wireless network 140 and the wireless network interface adapter 410. The service commands and data may include controlling power to the individual server machines 205, updating firmware on the server machines 205, configuring logical partitions on the server machines 205, collecting diagnostic information from the server machines 205, or any other appropriate service functions. Control then continues to block 915 where the server machine management control program 730 receives service commands and/or service data from the server machines 205 via the wireless network 140 and the wireless network interface adapter 410.

Control then continues to block 920 where the main processors 420 in the server machines 205 send/receive main commands/data to/from the server machines 205 and the server machine management controller 210 via the wireless network 140. For example, the main commands/data sent between the server machines 205 via the wireless network 140 may send work between the server machines 205, in order to perform load balancing functions. In other embodiments, the server machines 205 may send persistent disk data (e.g., over a Fibre Channel network), messages (e.g., over an Infiniband network), or any other appropriate commands/data/messages via any appropriate network.

Control then continues to block 999 where the logic of FIG. 9 returns. Although the logic of FIG. 9 is illustrated as if the execution of the logic in the blocks occurs sequentially in order, in another embodiment, the logic illustrated in the blocks of FIG. 9 may occur in any order.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of embodiments of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A server system comprising:
a plurality of server blades connected to each other via a wired connector; and
a blade management controller connected to at least one of the plurality of server blades via a wireless network.

2. The server system of claim 1, wherein the at least one of the plurality of server blades comprises:
a wireless network interface adapter connected to the wireless network; and
a service processor that interfaces to the blade management controller via the wireless network interface adapter.

3. The server system of claim 2, wherein each of the plurality of server blades comprises:
a main processor that interfaces to other of the plurality of server blades via the wired connector.

4. The server system of claim 1, wherein the blade management controller comprises:
a wireless network interface adapter connected to the wireless network; and
a master service processor that interfaces to the at least one of the plurality of server blades via the wireless network interface adapter.

5. The server system of claim 1, wherein the blade management controller further comprises:
a control program that communicates with the at least one of the plurality of server blades via the wireless network.

6. The server system of claim 5, wherein the control program further sends commands and data to the at least one of the plurality of server blades via the wireless network in response to a user interface.

7. The server system of claim 1, further comprising: a terminal connected to the blade management controller, wherein the terminal comprises:
a wireless network interface adapter connected to the wireless network; and
a master service processor that executes a control program to communicate with the at least one of the plurality of server blades via the wireless network interface adapter.

8. The server system of claim 1, wherein the wired connector comprises a circuit board.

9. The server system of claim 1, wherein the wired connector comprises a backplane.

10. The server system of claim 1, wherein the wired connector comprises a midplane.

11. The server system of claim 1, wherein at least some of the plurality of server blades are disposed within different housings.

12. The server system of claim 1, wherein all of the plurality of server blades are disposed within a same housing.

13. The server system of claim 1, wherein the blade management controller is disposed within a different housing from at least some of the plurality of server blades.

14. The server system of claim 1, wherein the blade management controller is disposed within a same housing as the plurality of server blades.

15. A server system comprising:
a plurality of server machines connected to each other via a wireless network, wherein the plurality of server machines are mounted in a rack; and
a management controller, wherein the management controller is connected to each of the server machines via the wireless network.

16. The server system of claim 16, wherein each of the plurality of server machines comprises:
a wireless network interface adapter connected to the wireless network; and
a service processor that interfaces to the management controller via the wireless network interface adapter.

17. The server system of claim 16, wherein each of the plurality of server machines comprises:
a main processor that interfaces to other of the plurality of server machines via the wired connector.

18. The server system of claim 16, wherein the management controller comprises:
a wireless network interface adapter connected to the wireless network; and
a master service processor that interfaces to each of the plurality of server machines via the wireless network interface adapter.

19. The server system of claim 16, wherein the management controller further comprises:
a control program that communicates with the plurality of server machines via the wireless network.

20. The server system of claim 19, wherein the control program further sends commands and data to each of the plurality of server machines via the wireless network in response to a user interface.

21. A method comprising:
receiving a user interface command via a wired connector; and
in response to the user interface command, sending a service command to a plurality of service processors at a plurality of server blades via a wireless network.

22. The method of claim 21, wherein the plurality of server blades communicate with each other via the wired connector.

23. The method of claim 21, wherein the service command comprises a request to update firmware at the plurality of server blades.

24. The method of claim 21, wherein the service command comprises a request to collect diagnostic data from the plurality of server blades.

25. The method of claim 21, wherein the service command comprises a request to control power to the plurality of server blades.

26. The method of claim 21, wherein the service command comprises a request to configure logical partitions at the plurality of server blades.

27. The method of claim 21, wherein the wired connector comprises a backplane.

28. The method of claim 21, wherein the wired connector comprises a midplane.

29. The method of claim 21, wherein at least some of the plurality of server blades are disposed within different housings.

30. The method of claim 21, wherein all of the plurality of server blades are disposed within a same housing.

31. A method for configuring a server system, comprising:
configuring the server system to receive a user interface command via a wired connector; and
configuring the server system to, in response to the user interface command, send a service command to a plurality of service processors at a plurality of server blades via a wireless network.

32. The method of claim 21, wherein the plurality of server blades communicate with each other via the wired connector.

33. The method of claim 21, wherein the service command comprises a request to update firmware at the plurality of server blades.

34. The method of claim 21, wherein the service command comprises a request to collect diagnostic data from the plurality of server blades.

35. The method of claim 21, wherein the service command comprises a request to control power to the plurality of server blades.

36. The method of claim 21, wherein the service command comprises a request to configure logical partitions at the plurality of server blades.

37. The method of claim 21, wherein the wired connector comprises a backplane.

38. The method of claim 21, wherein the wired connector comprises a midplane.

39. The method of claim 21, wherein at least some of the plurality of server blades are disposed within different housings.

40. The method of claim 21, wherein all of the plurality of server blades are disposed within a same housing.
